(19) United States
(12) Patent Application Publication
(10) Pub. No.: US 2005/0066090 A1
(43) Pub. Date: Mar. 24, 2005

(54) Method of using hotkeys to operate windowsTM calculatorTM and device of the same

(76) Inventor: Moai Chien, Taipei (TW)

Correspondence Address: HERSHKOVITZ & ASSOCIATES, 1725 I STREET NW, SUITE 300, WASHINGTON, DC, 20006, US

(21) Appl. No.: 10/939,485

(22) Filed: Sep. 14, 2004

(30) Foreign Application Priority Data
Sep. 19, 2003 (TW) 092125879

(51) Int. Cl. G06F 13/12; G06F 13/38

(52) U.S. Cl. 710/73

(57) ABSTRACT

A method of using hotkeys to operate a WINDOWS™ Calculator™ and device of the same include a standard keyboard or an extendible keypad having additional hotkeys. Each of the hotkeys corresponds to an original functional-button defined by an equivalent keystroke of the WINDOWS™ calculation of an application program. The hotkeys are scanned to detect whether the hotkeys are pressed. If any one of the hotkeys is pressed, a represented key code of the functional-button of the equivalent keystroke is sent to a computer, so that the WINDOWS™ Calculator™ of the application program can be operated directly by inputting the hotkeys. Furthermore, the keyboard includes at least a hotkey to copy an operation result to another application program, such as WORD™.

### BACKGROUND OF THE INVENTION

1. Field of the Invention

The invention relates in general to a method of using hotkeys to operate a WINDOWS™ Calculator™ and a device of the same, and more particularly to a method of using hotkeys to operate a WINDOWS™ Calculator™ of an application program and a device thereof, by which a person can directly use a keyboard to operate the WINDOWS™ Calculator™ without having to memorize compound or equivalent keystrokes.

2. Description of the Related Art

Despite the universal acceptance of computers in seemingly every aspect of modern life, some people may be unaware of the consumer resistance in the early days of general computing. That is, the DOS system was particularly unfriendly to operators and so anyone wishing to use a computer required considerable training and commitment. Later, the WINDOWS™ system provided a revolutionary solution to the former drawbacks, so as to greatly decrease a learning barrier for the novice. Nevertheless, the software industry has continued to strive for improvements to the WINDOWS™ system. For instance, Microsoft™ released WINDOWS 95, 98, ME, XP, and 2000, so as to meet the consumers' requirements.

No matter how many times the WINDOWS™ system is upgraded, the system is always provided with several practical application programs, such as Notepad™, Microsoft Paint™, and Calculator™. The WINDOWS™ Calculator™ is actually a standard/scientific dual-purpose calculator. Referring to FIG. 6, a standard WINDOWS™ Calculator™ is shown. Take the standard WINDOWS™ Calculator™ as an example, the Calculator™ includes not only numerical buttons and basic buttons of “+”, “−”, “*”, “/”, “=” at a side of the numerical buttons, but also includes buttons of CE, C, Sqrt (square), %, 1/× (reverse), MC, MR, MS, M+, and ±, which are represented by compound keys. When manipulating the buttons of a keyboard, the user must remember represented equivalent keystrokes or find out the equivalent keystrokes from a Help option. A mapping table of the equivalent keystrokes is shown in FIG. 7, which is derived from the Help option of the WINDOWS™ Calculator™. For example:

| Buttons | Keystrokes |
|---|---|
| M+ | CTRL+P |
| MC | CTRL+L |
| MR | CTRL+R |
| MS | CTRL+M |

In other words, when manipulating the WINDOWS™ Calculator™, if you want to press the MC button to clear values stored in a memory, you have to press both the CTRL button and the alphabet L button together. It is not difficult for an expert to manipulate the compound keys but it is still necessary to remember all of the defined compound keys, which is rather inconvenient.

The above-mentioned confusion is even more obvious when using a notebook computer. The conventional notebook computer decreases a size of a keyboard to achieve a compact feature, whereby numerical keystrokes and alphabetic keystrokes are allotted to the same keys on the keyboard. For example, if you want to input a number, you need to press the SHIFT button together with a shared number key. The inconvenience may be not obvious for some cases where the numbers are seldom inputted. However, once the user requires inputting of a great deal of numbers, the above-mentioned method of manipulating the WINDOWS™ Calculator™ with the compound keys becomes very inconvenient and unfavorable. In order to solve such a troublesome drawback, a notebook computer 70 with an extendible keyboard 80 having dedicated numerical buttons as in FIG. 8 was presented. However, the extendible keyboard 80 still cannot solve the problem of the compound keys.

To sum up, whether using the standard keyboard or the notebook having the external extendible keyboard, both are very inconvenient in using the Microsoft WINDOWS™ Calculator . Thus, there is a need for a convenient device to overcome the aforementioned drawback.

### SUMMARY OF THE INVENTION

It is an objective of the present invention to provide a method of directly using a keyboard to operate a WINDOWS™ Calculator™ of an application program without need for an operator to memorize compound or equivalent keystroke tables.

In order to achieve the above-mentioned objective, a main technique is used by having a plurality of additional hotkeys on a keyboard, and also having each of the hotkeys corresponding to an original functional-button defined by an equivalent keystroke. Moreover, the following steps are executed: The hotkeys on the keyboard are scanned to detect whether the hotkeys are pressed. If any one of the hotkeys is pressed, a represented key code of the functional-button of the equivalent keystroke is sent to a computer. In this way, the WINDOWS™ Calculator™ of an application program can be operated directly by inputting the hotkeys, so that a user need not memorize the defined equivalent keystrokes.

A hotkey of the plurality of the hotkeys executes a numerical duplicate function to duplicate an operation result of the WINDOWS™ Calculator™ to an editing frame of another application program that an operator is using.

The numerical duplicate function of the hotkey comprises a copy function and a paste function. When the hotkey is pressed, the key codes of the hotkey of the copy and paste functions are sent out to the computer sequentially, so that an operation value of the WINDOWS™ Calculator™ is duplicated to the editing frame of another application program that the operator is using.

One of the hotkeys functions as a shortcut to call the WINDOWS™ Calculator™. According to another object of the present invention, a keyboard that can directly operate a WINDOWS™ Calculator™ is provided.

In order to achieve the above-mentioned object, a main technique is used by a keyboard comprising basic keys and further comprising a plurality of additional hotkeys. Each of the hotkeys corresponds to an original functional-button defined by an equivalent keystroke of the WINDOWS™ Calculator™ of an application program. Moreover, a microprocessor is installed in the keyboard for connecting to the basic keys and the hotkeys. In addition, the following steps are executed. The hotkeys on the keyboard are scanned to detect whether the hotkeys are pressed. If any one of the hotkeys is pressed, a represented key code of the functional-button of the equivalent keystroke is sent to a computer.

The microprocessor comprises a plurality of I/O lines and a plurality of data lines. The I/O lines are decoded by a decoder to transform into more output data lines. The output data lines and the data lines are arranged in a matrix to comprise the basic keys and the hotkeys. The keyboard is a standard keyboard used for a personal computer. Further, the keyboard can be an external extendible keypad for a notebook computer. In addition, a multiplexer processor can replace the decoder. The decoder or the multiplexer processor is built in the microprocessor.

### BRIEF DESCRIPTION OF THE DRAWINGS

FIG. 1 shows a system diagram of a preferred embodiment of the present invention.

FIG. 2 shows a plan diagram of an extendible keypad according a preferred embodiment of the present invention.

FIG. 3 shows a keyboard circuit diagram of a preferred embodiment of the present invention.

FIG. 4 shows a workflow chart of the present invention.

FIG. 5 shows a perspective view of a preferred embodiment of the present invention.

FIG. 6 shows a computer generated diagram of a WINDOWS™ Calculator™.

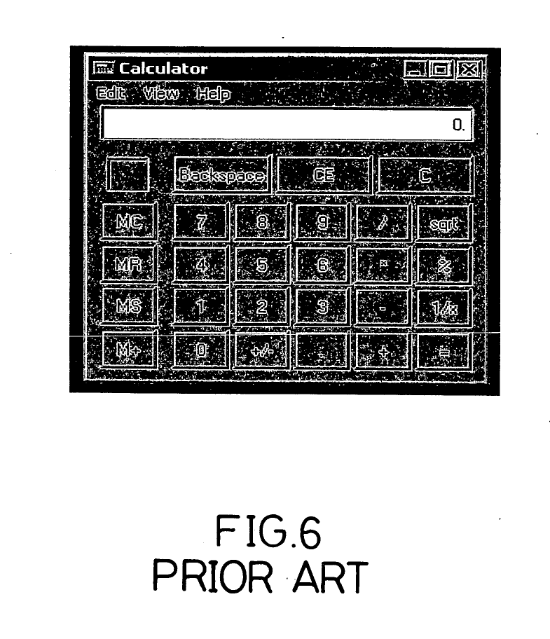

FIG. 7 shows functional buttons of the WINDOWS™ Calculator™ of an application program and a mapping table for equivalent keystrokes, wherein the mapping table is captured from the “Help” option of the WINDOWS™ Calculator™.

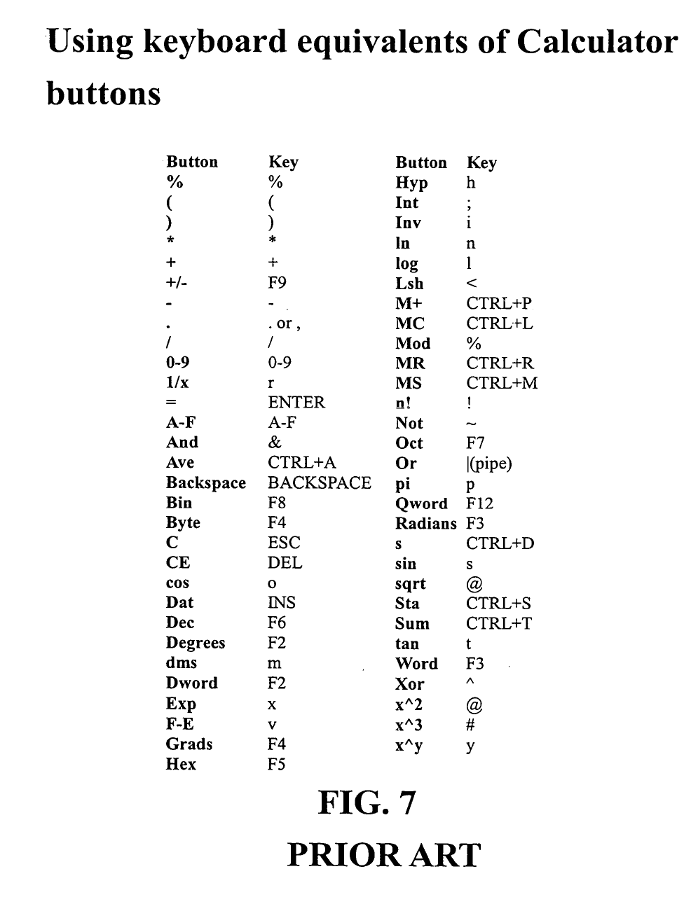

FIG. 8 shows an external extendible keypad diagram of an original notebook computer.

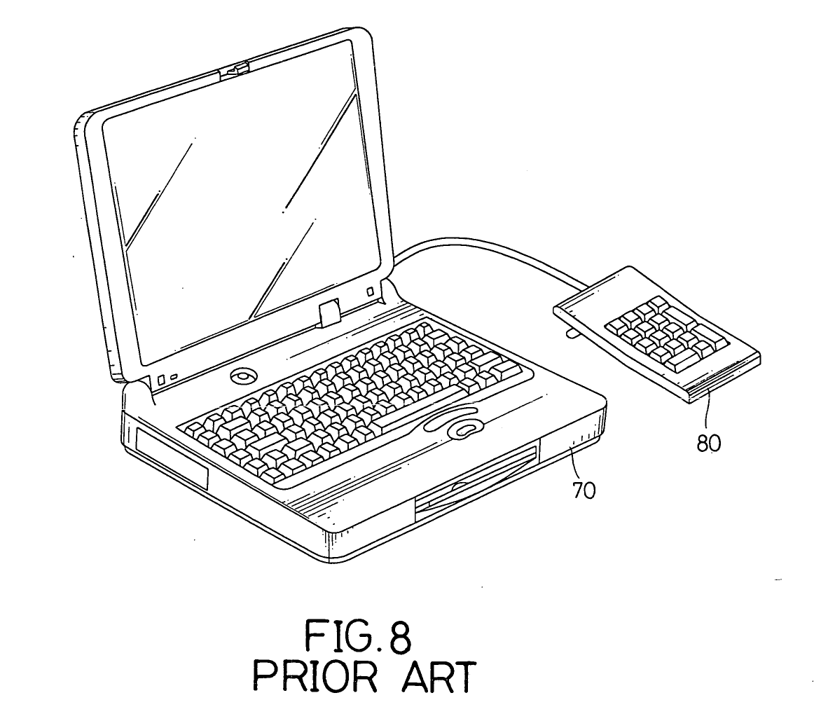

### DETAILED DESCRIPTION OF THE INVENTION

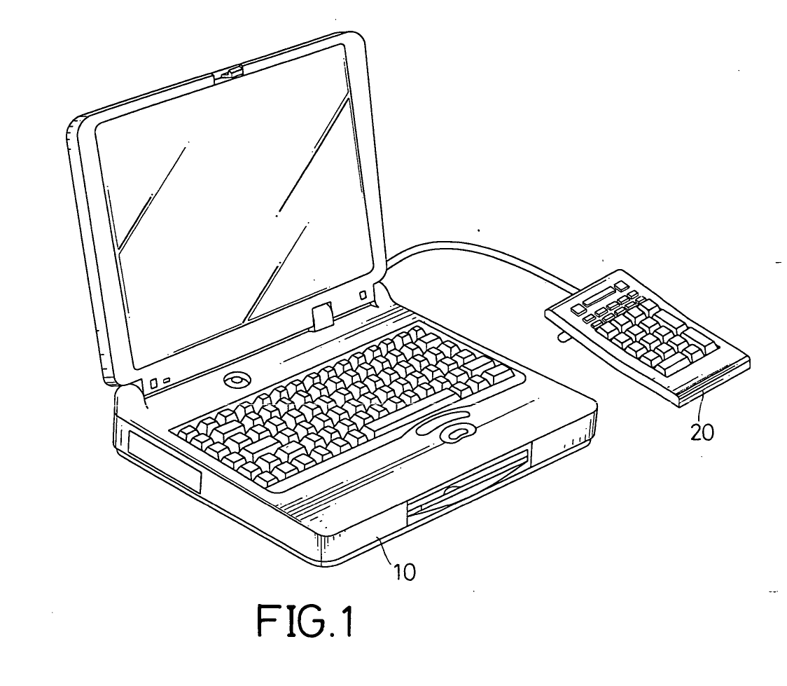

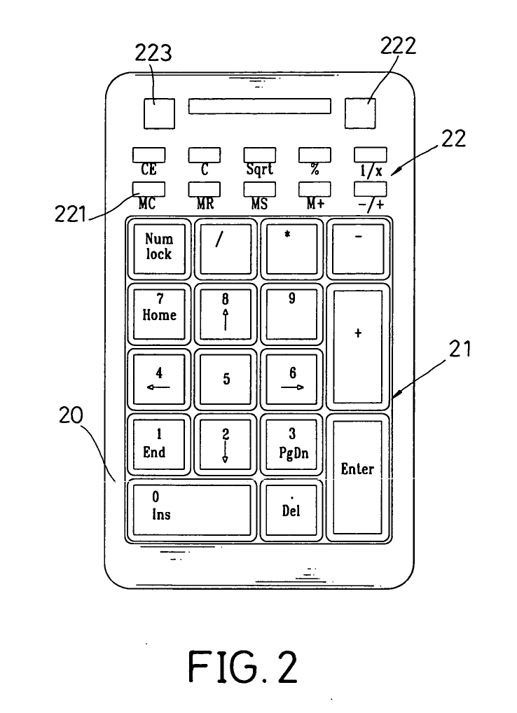

Referring to FIG. 1, a system diagram of a preferred embodiment in accordance with the present invention is shown. A notebook computer 10 connects an extendible keypad 20 for inputting numbers and for subordinate functions. Referring to FIG. 2, the extendible keypad 20 includes a set of basic keys 21 and a set of hotkeys 22 having a plurality of the hotkeys 221 to 223. The set of the basic keys 21 is formed by original keys of the extendible keypad 20, such as basic numerical keys 000,0˜9, and basic keys of NumLock, +, −,“·”, *, /, ENTER, and so on. In addition, the hotkeys 221 correspond to original functional-buttons defined by equivalent keystrokes of the WINDOWS™ Calculator™ of an application program, such as CE, C, Sqrt (square), %, 1/× (inverse) , MC, MR, MS, M+, ±, and so on. Moreover, a hotkey 222 is used to duplicate an operation value that is calculated by the WINDOWS Calculator™ to another application program that an operator is using. In other words, the hotkey 222 includes copy and paste functions. Another hotkey 223 is used to call the subordinate application program of the WINDOWS™ Calculator™ directly in a Windows system.

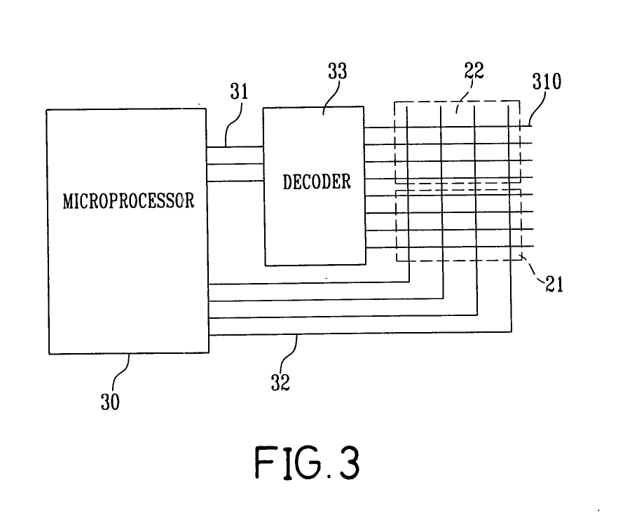

Referring to FIG. 3, an interior circuit diagram of the extendible keypad 20 of a preferred embodiment is shown. A microprocessor 30 includes a plurality of I/O lines 31 and a plurality of data lines 32. A decoder 33 decodes the I/O lines 31 as more output data lines 310. The output data lines 310 and the data lines 32 are arranged in a matrix to comprise the set of the basic keys 21 and the set of the hotkeys 22. When using a 3 to 8 decoder such as a serial number 74L138, only three I/O lines are needed to generate a number of 2⁼⁸ of the output data lines 310. When using different decoders, four I/O lines can generate a number of 2⁼16 of the output data lines 310, and five I/O lines can generate a number of 2⁼32 of the output data lines 310. In this way, the fewest I/O lines can be used to comprise a keyboard matrix, so as to reduce cost efficiently.

A multiplexer processor can replace the decoder 33 and can be built in the microprocessor 30.

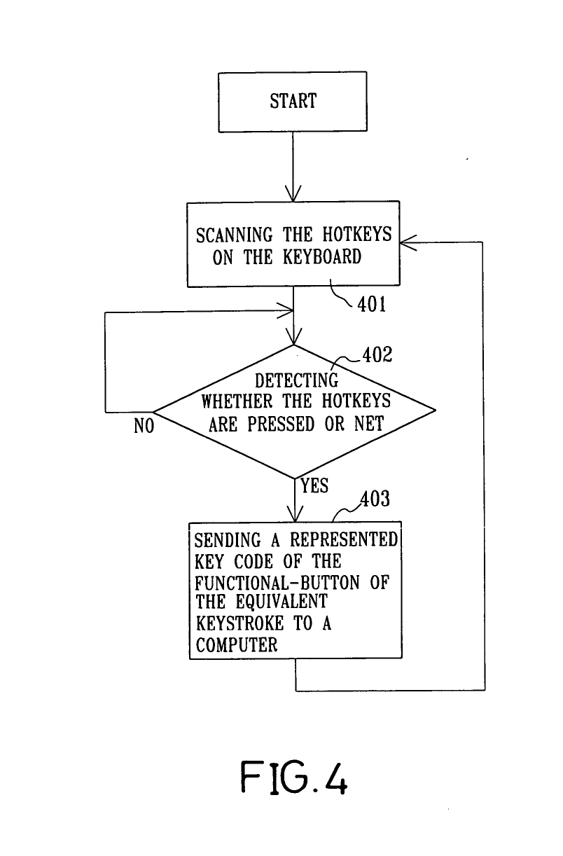

FIG. 4 shows a diagram regarding a workflow of the set of the hotkeys 22 of the extendible keyboard 20. The workflow includes the steps 401-403 as follows. A step 401 is scanning the hotkeys on the keyboard 22, and then a step 402 is to detect whether the hotkeys are pressed or not. If any one of the hotkeys is pressed, a step 403 of sending a represented key code of the functional-button of the equivalent keystroke to a computer is executed. With the above-mentioned method, the microprocessor 30 includes a built-in program and default key codes of the equivalent keystrokes. When the corresponding defined hotkey is pressed, the microprocessor 30 sends out the compound key codes of the equivalent keystrokes to the notebook computer 10, so as to form a same result as pressing the compound keystrokes. In this way, the WINDOWS™ Calculator™ can be operated directly by inputting the hotkeys, so as to eliminate having to remember the defined equivalent keystrokes.

In addition, when pressing the hotkey 222 to execute the function of numerical value duplication, the microprocessor 30 sends out the compound key codes of CTRL-C and CTRL-V representing the copy and paste functions to the notebook computer 10. That is to say, when the hotkey 222 is pressed, the key codes of the hotkey of the copy and paste functions are sent out to the notebook computer 10 sequentially. Thereby the operation result of the WINDOWS™ Calculator™ is duplicated to the editing frame of another application program such as Microsoft WORD™ that the operator is using, so as to facilitate utilization of the operation result.

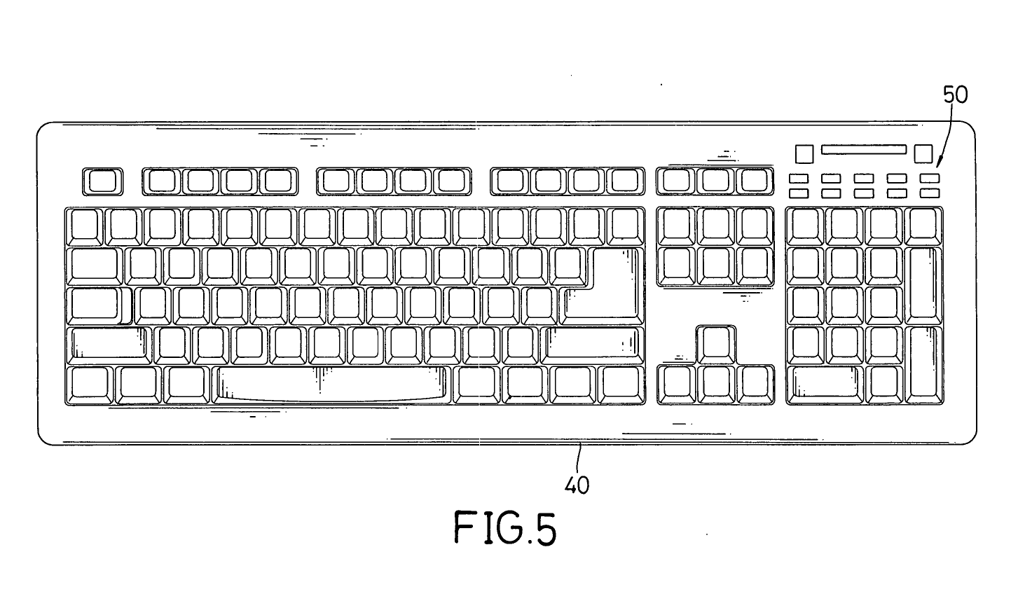

The above-mentioned example of the preferred embodiment uses the external extendible keypad 20 connected to the notebook computer 10 as the example to illustrate the method of directly operating the WINDOWS™ Calculator™. However, the present invention can be applied not only in the external extendible keypad 20 of the notebook computer 10, but also in a standard keyboard or a multimedia keyboard of a personal computer. Referring to FIG. 5, a set of hotkeys 50 is added on a keyboard 40. A composition and functions of the set of the hotkeys 50 are the same as the above-mentioned set of the hotkeys 22 of the extendible keyboard 20, and also a workflow of the set of the hotkeys 50 is the same as the above-mentioned example of the preferred embodiment.

Further, according to the above-mentioned examples of the preferred embodiments of the present invention, no matter whether the set of the hotkeys is of the extendible keypad or the multimedia keyboard, the present invention is designed for the standard WINDOWS Calculator™. However, the present invention also can provide more hotkeys for a scientific Calculator™ in order to manipulate the scientific Calculator™ directly.

The present invention accordingly provides the method of using the extendible hotkeys of the keyboard to manipulate the WINDOWS™ Calculator™ directly. Therefore, the present invention can eliminate confusion otherwise arising from the need to remember the compound equivalent keystrokes, so as to facilitate utilization of the WINDOWS calculator. Moreover, the present invention includes the I/O lines of the microprocessor that are decoded by the decoder or processed by the multiplexer processor to generate more output data lines to form the keyboard matrix. In this way, the fewest I/O lines can be used to achieve an object of expanding the plurality of the hotkeys, so as to take an advantage of reducing cost effectively. Therefore, the present invention exactly comprises utility and conforms to novelty non-obviousness and inventive step of requirements of a patent.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A method of using hotkeys to operate a WINDOWS™ Calculator™ comprising a keyboard having a plurality of additional hotkeys, wherein each of the hotkeys corresponds to an original functional-button defined by an equivalent keystroke of the WINDOWS™ Calculator™, and wherein the following steps are executed:
scanning the hotkeys on the keyboard to detect whether the hotkeys are pressed;
if any one of the hotkeys is pressed, a represented key code of the functional-button of the equivalent keystroke is sent to a computer, so that the WINDOWS™ M Calculator™ is operated directly by inputting the hotkeys.

2. The method as claimed in claim 1, wherein a hotkey of the plurality of the hotkeys executes a numerical duplicate function to duplicate an operation result of the WINDOWS™ Calculator™ to an editing frame of another application program that an operator is using.

3. The method as claimed in claim 2, wherein the numerical duplicate function of the hotkey comprises a copy function and a paste function.

4. The method as claimed in claim 1, wherein a hotkey of the plurality of the hotkeys functions as a shortcut to call the WINDOWS™ Calculator™.

5. The method as claimed in claim 3, wherein one hotkey of the plurality of the hotkeys functions as a shortcut to call the WINDOWS™ M Calculator™.

6. A keyboard of using the hotkeys to operate a WINDOWS™ Calculator™, the keyboard comprises basic keys and a plurality of additional hotkeys, wherein each of the hotkeys corresponds to an original functional-button defined by an equivalent keystroke of the WINDOWS™ Calculator™ of an application program; wherein a microprocessor is installed in the keyboard for connecting to the basic keys and the hotkeys; wherein the following steps are executed:
scanning the hotkeys on the keyboard to detect whether the hotkeys are pressed;
if any one of the hotkeys is pressed, a represented key code of the functional-button of the equivalent keystroke is sent to a computer.

7. The keyboard as claimed in claim 6, wherein the keyboard is a standard keyboard or a multimedia keyboard used for a personal computer.

8. The keyboard as claimed in claim 6, wherein the keyboard is an external extendible keypad for a notebook computer.

9. The keyboard as claimed in claim 6, wherein the microprocessor comprises a plurality of I/O lines and a plurality of data lines, wherein the I/O lines are decoded by a decoder to transform into more output data lines wherein the output data lines and the data lines are arranged in a matrix to comprise the basic keys and the hotkeys.

10. The keyboard as claimed in claim 9, wherein the decoder is built in the microprocessor.

11. The keyboard as claimed in claim 9, wherein the decoder is performed by a multiplexer processor.

12. The keyboard as claimed in claim 10, wherein the decoder is performed by a multiplexer processor.
